(19) United States
(12) Patent Application Publication
(10) Pub. No.: US 2009/0275229 A1
(43) Pub. Date: Nov. 5, 2009

(54) DEVICE FOR ELECTRICAL CONNECTION OF ELECTRICAL OR ELECTRONIC COMPONENTS

(75) Inventors: Harald Neumayer, Vienna (AT); Walter Plank, Vienna (AT)

Correspondence Address: CHAPMAN AND CUTLER, 111 WEST MONROE STREET, CHICAGO, IL, 60603, US

(73) Assignee: EVVA-WERK Spezialerzeugung von Zylinder- und Sicherheitsschlossern Gesellschaft m.b.H. & Co. KG, Vienna (AT)

(21) Appl. No.: 12/225,227

(22) PCT Filed: Feb. 16, 2007
(86) PCT No.: PCT/AT2007/000085

§ 371 Date: Sep. 16, 2008

(30) Foreign Application Priority Data
Mar. 29, 2006 (AT) A 536/2006

(51) Int. Cl. H01R 13/629

(52) U.S. Cl. 439/352

(57) ABSTRACT

In a device for the electrical connection of electrical or electronic components which are arranged on different sides of an electronic lock in pivotable or rotational operating members for the lock, which are connectable in a rotationally fast manner with a locking nose (6) of the lock via an interposed coupling shaft (3) passing through the lock, the coupling shaft (3) comprises an axial groove in which electrical wires or cables (1) are inserted. The coupling shaft (3) carrying the wires or cables (1) carries a sleeve (4) slipped on the coupling shaft (3) and reaching into a hollow shaft (7), the coupling shaft (3) is connected in a rotationally fast manner with the electrical or electronic components to be connected, or their boards, and the hollow shaft (7), which is connectable or connected with an operating member, operates the locking nose (6) for the lock and can be coupled to the coupling shaft (3) carrying the electronic components.

The invention relates to a device for the electrical connection of electrical or electronic components which are arranged on different sides of an electronic lock in pivotable or rotational operating members for the lock, which are connectable in a rotationally fast manner with a locking nose of the lock via an interposed coupling shaft passing through the lock.

Electronic locking devices of the initially defined kind are, for instance, described in DE 29911097 U1. Such electronic locking devices comprise a closure including an inwardly located housing part and an outwardly located housing part for operating a bolt arranged between the two housing parts, wherein electrical and electronic components for operating the locking device are each received in the two housing parts. The two housing parts, which are each formed by a knob in the event of a double-knob cylinder lock, in their cavities each contain the respective means for operating the locking device and, in particular, the contact or reading device for an identification medium on the outer side and the evaluation switch or coupling drive on the inner side. Those two electrical or electronic components have to be electrically connected via an electrical connection guided through the lock. To this end, DE 29911097 U1 provides a thrust-resistant conductor track carrier capable of being inserted into an appropriate seat provided on the respectively opposite site, said seat being designed as a contact bush and connected with the conductor tracks via a plurality of contacts. Hereby, a plurality of conductor tracks is arranged in parallel. In order to ensure safe electrical contacting, the respective conductor tracks must have minimal widths so as to enable the compensation of tolerances, whereby the conductor track carrier can be inserted differently deeply into the bush to take into account different thicknesses of doors to which such locking devices are fixed. Due to that tolerance compensation and the necessity to ensure electrical contacting even in the axial direction at a displacement of the conductor track carrier, the conductor tracks themselves have to be dimensioned relatively wide and, as a result, three conductor tracks are, for instance, provided in parallel on the conductor track carrier in that known configuration. The arrangement of a substantially larger number of conductor tracks is not readily feasible for reasons of space and, with the selected plug contact connection type, would also entail problems relating to the contacting safety as well as tolerance problems.

The invention aims to provide a device of the initially defined kind, by which also a large number of electrical conductors can be safely guided from one side to the other side of the locking device without involving the risk of wear and damage by rotating components, while, at the same time, also ensuring the appropriate safety in the contacting of a large number of electrical lines with the electronic components.

To solve this object, the device according to the invention essentially consists in that the coupling shaft comprises an axial groove in which electrical wires or cables are inserted, that the coupling shaft carrying the wires or cables carries a sleeve slipped on the coupling shaft and reaching into a hollow shaft, that the coupling shaft is connected in a rotationally fast manner with the electrical or electronic components to be connected, or their boards, and that the hollow shaft, which is connectable or connected with an operating member in a rotationally fast manner, operates the locking nose for the lock and can be coupled to the coupling shaft carrying the electronic components.

Due to the fact that the electrical wires or cables are inserted in grooves of the coupling shaft, it is possible to use conventional flat band cables, and due to the fact that such flat band cables or wires, or cables, are subsequently mechanically protected by a sleeve slipped on the coupling shaft, it is possible to use even relatively thin wires and, hence, highly flexible cables. Contacting with such flat band cables is feasible with conventional couplings for such flat band cables, whereby usual print plugs may be used, which, by slipping on, can be electrically connected with the contact pins arranged in a relatively narrow manner in correspondence with the grid of the printed circuit board. The plugs themselves are relatively small and contain adjacent contacts at slight distances, wherein, in the configuration according to the invention, a plurality of different cables, wires and/or flat band cables can also be employed due to the arrangement of a plurality of grooves about the circumference of the coupling shaft. The cable overlength required for contacting in the event of flat band cables can be readily placed into relatively small cavities by folding into an S-shaped configuration, whereupon the operating members and, in particular, the respective knob can be readily slipped on and fixed. In this manner, it is possible to accommodate an accordingly large number of electrical conductors in a very small space in a safe and protected fashion, the mechanical protection being ensured to a high degree by the substantially clampingly slipped-on sleeve.

In a particularly advantageous manner, the configuration is devised such that the sleeve slipped on the coupling shaft has a larger radial play relative to the hollow shaft than relative to the coupling shaft. In this manner, it is safeguarded that the sleeve itself remains non-rotationally connected with the coupling shaft, when the sleeve is freely turned along with the coupling member. In this case, the electronic component arranged in the interior of the inwardly located knob, which component is itself not yet coupled with the knob or the hollow shaft operating the locking nose, is rotated, with the hollow shaft accordingly remaining in its resting position until the electrical coupling takes effect. In order to ensure such a free rotability in any event, the configuration is advantageously devised such that the sleeve slipped on the coupling shaft, on its jacket outer surface, is polished or carries a friction-reducing coat.

In an electronic lock of this type, the release of the bolt and, hence, the opening of the lock are effected after the identification of the identification medium and an evaluation confirming the legitimacy of the identification medium as a key. In this case, a coupling is operated, whereby the configuration in a particularly simple manner can be realized in that the hollow shaft is coupled in a rotationally fast manner via a coupling with a ring carrying the locking nose.

The initially mentioned plurality of electrical conductors, for instance in the form of a flat band cable, may be provided with conventional circuit board plugs in a very small space with the respective electronic components for reading the identification medium with contact, or the identification of the contactless identification medium, for the evaluation electronics. To this end, the configuration is advantageously devised such that the free ends of the flat band cables are connected with plug contacts and, in particular, plug bushes for printed circuit board pin contacts.

In the following, the invention will be explained in more detail by way of an exemplary embodiment schematically illustrated in the drawing. Therein,

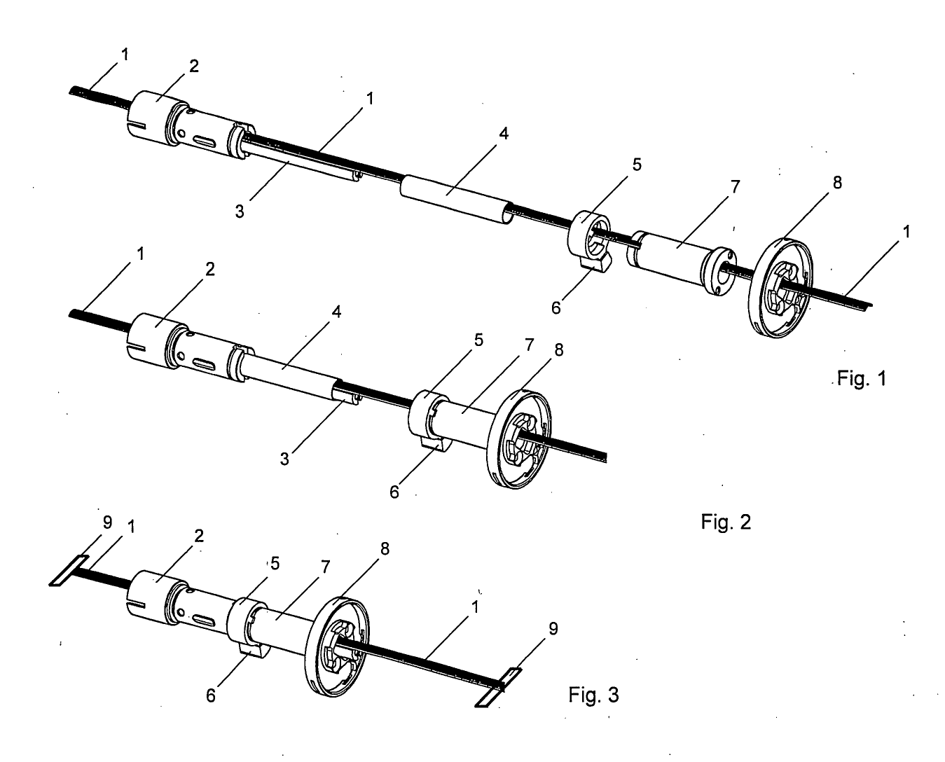

FIG. 1 is an exploded view of the components required for the cable bushing;

FIG. 2 illustrates the components according to FIG. 1 in a partially assembled state; and

FIG. 3 is a perspective view of the assembled state of the device according to the invention.

In FIG. 1, a flat band cable is denoted by 1, which passes through a part of an operating shaft 2, which is connected with the outwardly located knob. The shaft 2 carries a coupling shaft 3 provided with an appropriate groove on its circumference, into which the flat band cable 1 is inserted. Onto this coupling shaft 3 and the inserted flat band cable is subsequently slipped a sleeve 4 in a manner that the flat band cable is covered as illustrated in FIG. 2 and connected with the coupling shaft 3 in a manner protected from wear. FIG. 1 further depicts a component or ring 5, whose locking nose is denoted by 6. This component is connected with a hollow shaft 7 in a rotationally fast manner, said hollow shaft being, in turn, connected with a knob disc 8 in a rotationally fast manner. The flat band cable 1 again passes through the hollow shaft 7 and the knob disc 8. In the assembled state according to FIG. 2, it is to be seen that a knob connected with the knob disc 8 in a rotationally fast manner is able to turn the component 5 carrying the locking nose 6 via the hollow shaft 7. The coupling shaft 3 subsequently pushed through this component is slidingly guided in the interior of the hollow shaft 7 via the interposed sleeve 4 and is, therefore, unable to rotate the locking nose 6 upon operation of an externally located knob not illustrated. From the assembled state, it is apparent that the coupling shaft 3 passes through the knob disc 8. This coupling shaft 3 in a rotationally fast manner can be connected with an evaluation circuit not illustrated, which may, in turn, also carry the coupling drive. The required plug connections are indicated by 9 in FIG. 3 on both sides of the flat band cable. A rotation of the operating shaft 2 and the coupling shaft 3 causes the evaluation circuit and the respective carrier for the coupling in the interior of the knob connected with the knob disc 8 to turn freely. It is only after a correct identification that the knob disc 8 and the coupling member arranged on the board are coupled, whereby the operation of the shaft 2 will subsequently also cause the knob disc 8 and hence the hollow shaft 7 to rotate, thus enabling the nose 6 for operating the bolt to be moved accordingly.

1. A device for electrical connection of electrical or electronic components which are arranged on different sides of an electronic lock in pivotable or rotational operating members for the lock, comprising:
a locking nose of the lock connected in a rotationally fast manner to said operating members via an interposed coupling shaft (3) passing through the lock,
wherein the coupling shaft (3) comprises an axial groove into which electrical wires or cables (1) are inserted,
the coupling shaft (3) carrying the wires or cables (1) carries a sleeve (4) slipped onto the coupling shaft (3) and inserted into a hollow shaft (7),
the coupling shaft (3) is connected in a rotationally fast manner with the electrical or electronic components to be connected, or to boards of said components, and
the hollow shaft (7),
is connected with a first one of the operating members in a rotationally fast manner,
operates the locking nose (6) for the lock, and
is adapted to be coupled to the coupling shaft (3) carrying the electrical or electronic components.

2. A device according to claim 1, the sleeve (4) slipped on the coupling shaft (3) has a larger radial play relative to the hollow shaft (7) than relative to the coupling shaft (3).

3. A device according to claim 1, wherein the sleeve (4) slipped on the coupling shaft (3), on its jacket outer surface, is polished or carries a friction-reducing coat.

4. A device according to claim 1, wherein the hollow shaft (7) is coupled in a rotationally fast manner via a coupling with a ring (5) carrying the locking nose (6).

5. A device according to claim 1, wherein free ends of the electrical wires or cables (1) are connected with plug contacts.

6. A device according to claim 1, wherein the electrical wires or cables comprise a flat band cable.

7. A device according to claim 5, wherein the plug contacts are plug bushes for printed circuit board pin contacts.

8. A device according to claim 2, wherein the sleeve (4) slipped on the coupling shaft (3), on its jacket outer surface, is polished or carries a friction-reducing coat.

9. A device according to claim 2, wherein the hollow shaft (7) is coupled in a rotationally fast manner via a coupling with a ring (5) carrying the locking nose (6).

10. A device according to claim 3, wherein the hollow shaft (7) is coupled in a rotationally fast manner via a coupling with a ring (5) carrying the locking nose (6).

11. A device according to claim 8, wherein the hollow shaft (7) is coupled in a rotationally fast manner via a coupling with a ring (5) carrying the locking nose (6).

12. A device according to claim 2, wherein free ends of the electrical wires or cables (1) are connected with plug contacts.

13. A device according to claim 3, wherein free ends of the electrical wires or cables (1) are connected with plug contacts.

14. A device according to claim 4, wherein free ends of the electrical wires or cables (1) are connected with plug contacts.

15. A device according to claim 8, wherein free ends of the electrical wires or cables (1) are connected with plug contacts.

16. A device for electrical connection of electrical or electronic components which are arranged on different sides of an electronic lock in pivotable or rotational operating members for the lock, comprising:
a locking nose of the lock connected in a rotationally fast manner to said operating members via an interposed coupling shaft (3) passing through the lock,
wherein the coupling shaft (3) comprises an axial groove into which electrical wires or cables (1) are inserted,
the coupling shaft (3) carrying the wires or cables (1) carries a sleeve (4) slipped onto the coupling shaft (3) and inserted into a hollow shaft (7),
the coupling shaft (3) is connected in a rotationally fast manner with the electrical or electronic components to be connected, or to boards of said components,
the hollow shaft (7)
is connected with a first one of the operating members in a rotationally fast manner,
operates the locking nose (6) for the lock, and
is adapted to be coupled to the coupling shaft (3) carrying the electrical or electronic components,
the sleeve (4) slipped on the coupling shaft (3) has a larger radial play relative to the hollow shaft (7) than relative to the coupling shaft (3),
the sleeve (4) slipped on the coupling shaft (3), on its jacket outer surface, is polished or carries a friction-reducing coat,
the hollow shaft (7) is coupled in a rotationally fast manner via a coupling with a ring (5) carrying the locking nose (6),
free ends of the electrical wires or cables (1) are connected with plug contacts,
the electrical wires or cables comprise a flat band cable, and
the plug contacts are plug bushes for printed circuit board pin contacts.
